(19) United States
(12) Patent Application Publication
(10) Pub. No.: US 2013/0238275 A1
(43) Pub. Date: Sep. 12, 2013

(54) THERMAL PROTECTION CRITICAL TEMPERATURE SETTING DEVICE, SYSTEM AND METHOD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: BIN CHENG, Shenzhen (CN); JI-CHAO LI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/734,940

(22) Filed: Jan. 5, 2013

(30) Foreign Application Priority Data
Mar. 12, 2012 (CN) 201210063111.8

(51) Int. Cl. G01K 1/12; G06F 15/00

(52) U.S. Cl. CPC G01K 1/12; G06F 15/00
USPC 702/132

(57) ABSTRACT

A device for setting a thermal protection critical temperature of a switching power supply, the switching power supply including a plurality of power supply elements and a temperature-sensing element. A temperature measurement element of the device measures temperatures of the power supply elements. Difference in temperature between the temperature of each of the power supply elements and a reduced rated temperature of each of the power supply elements is calculated, and a largest difference in temperature from the temperature of the temperature-sensing element is calculated.

### BACKGROUND

1. Technical Field

Present disclosure is related to devices for setting a thermal protection critical temperature, and is further related to a device, a system, and a method for the thermal protection critical temperature of a switching power supply.

2. Description of Related Art

To increase a reliability of an element, a working temperature of the element is designed to be lower than a reduced rated temperature. The reduced rated temperature of the element is a reduction of a rated temperature of the element. For example, an temperature of the element is normally limited to be smaller than 80% of the rated temperature when the element is working, and the reduced rated temperature is the 80% of the rated temperature.

In thermal protection methods of a switching power supply, a power supply of a main board for example, the temperatures of a transistor, an inductor, and other electronic elements are less than the reduced rated temperatures of the elements. A temperature-sensing element is set around the transistor to measure the temperature of the transistor. When the temperature of the transistor reaches the reduced rated temperature, a power controller of the switching power supply starts to execute the thermal protection methods for the switching power supply. The thermal protections methods are controlling a central processing unit to reduce a working frequency and controlling a fan to increase a rotational speed of the fan. And the temperature of the temperature-sensing element is the thermal protection critical temperature of the switching power supply.

But, each of the power supply elements in the switching power supply has a different reduced rated temperature. When the power supply element which is in an outer area exceeds the reduced rated temperature of the power supply element, the temperature-sensing element may not reach the reduced rated temperature of the temperature-sensing element, and the power controller thus does not execute the thermal protection to the switching power supply. The temperature of the temperature-sensing element may exceeds the reduced rated temperature, and the temperature-sensing element may work in a hot environment and suffer a decrease in service life, and even more so, the service life of the switching power supply is decreased.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a functional module diagram of one embodiment of the present disclosure of a switching power supply of a thermal protection critical temperature setting device.

FIG. 2 is a functional module diagram of one embodiment of the present disclosure of the thermal protection critical temperature setting device.

### DETAILED DESCRIPTION

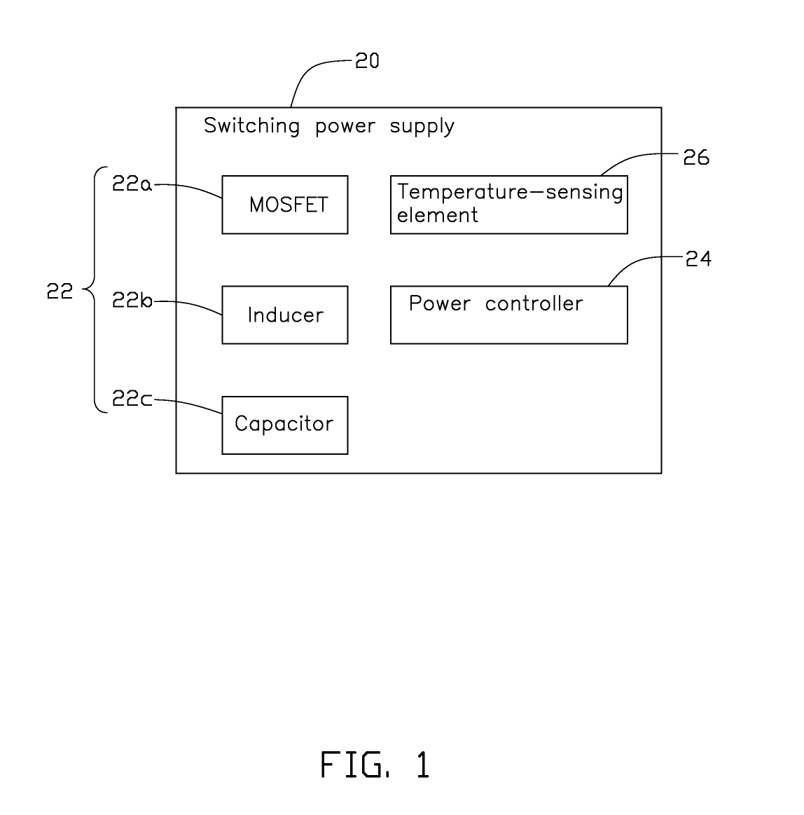

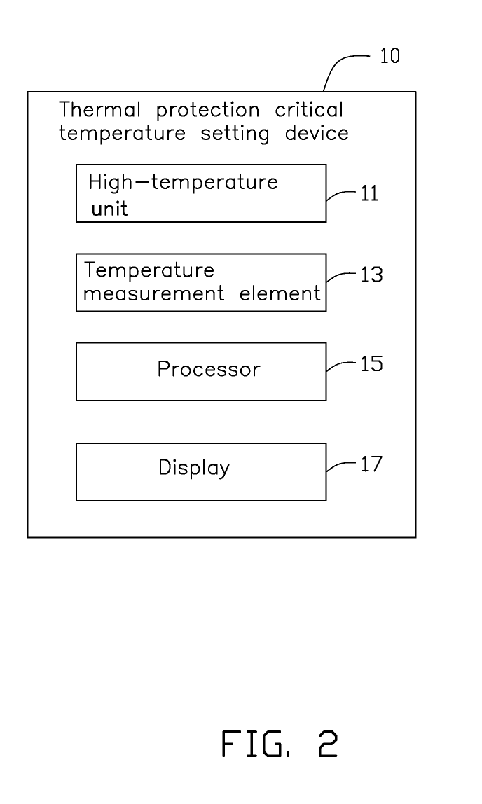

FIG. 1 and FIG. 2 are embodiments of present disclosure of thermal protection critical temperature setting system. The system includes a switching power supply 20 and a thermal protection critical temperature setting device 10 for setting a thermal protection critical temperature of the switching power supply 20.

In the embodiment, the switching power supply 20 is used in a computer (not shown) and supplies electrical power to elements of the computer. The switching power supply 20 includes a plurality of power supply elements 22 set on a circuit board, a power controller 24, and a temperature-sensing element 26 electronically connected to the power controller 24. The power supply elements 22 comprise a metal-oxide-semiconductor field-effect transistor (MOSFET) 22a, an inductor 22b, and a capacitor 22c. In the embodiment, the temperature-sensing element 26 is a thermistor. Each of the power supply elements 22 has a reduced rated temperature, for example, the reduced rated temperature of the inductor 22b is seventy-five degrees Celsius, and the reduced rated temperature of the MOSFET 22a is one-hundred-twenty-five degrees Celsius. The temperature-sensing element 26 is set close to the MOSFET 22a and the inductor 22b. Temperature of the temperature-sensing element 26 increases when the temperature of the power supply elements 22 increases. When the temperature of the temperature-sensing element 26 reaches the thermal protection critical temperature of the switching power supply 20, the power controller 24 executes thermal protection methods for the switching power supply 20. For example, the power controller 24 controls a central processing unit to reduce processing speed of the processor, or controls a fan of the computer to increase a rotational speed of the fan.

The device 10 includes a high-temperature unit 11, a temperature measurement element 13, and a processor 15. The high-temperature unit 11 increases an ambient temperature of the switching power supply 20 until the ambient temperature of the switching power supply 20 about equals to temperature of the switching power supply 20 in a working state. In the embodiment, the ambient temperature of the switching power supply 20 is thirty-five degrees Celsius. The switching power supply 20 in the working state is subjected to a load such as the central processing unit, for example.

The temperature measurement element 13 measures temperatures of each of the power supply elements 22 and the temperature-sensing element 26, and transmits the temperatures to the processor 15. In the embodiment, the temperature measurement element 13 is a thermocouple wire electronically connected to the processor 15.

Data as to the reduced rated temperature of each of the power supply elements 22 is saved by the processor 15. The processor 15 compares the temperature of each of the power supply elements 22 with the reduced rated temperature of each of the power supply elements 22. When at least one temperature of the power supply elements 22 is greater than the reduced rated temperature of the of the power supply element 22, the processor 15 calculates the difference in temperature between the at least one temperature and the reduced rated temperatures for establishing the greatest difference. The processor 15 subtracts the greatest difference from the temperature of the temperature-sensing element 26, and a result of the above subtraction is a thermal protection critical temperature of the switching power supply 20.

A high temperature test is controlling the high-temperature unit 11 to raise the ambient temperature of the switching power supply 20 until the ambient temperature equals temperature of the switching power supply 20 in a working state. For example, when the switching power supply 20 is put into the high-temperature unit 11 to undergo the high temperature test, the temperature of the capacitor 22c measured by the temperature measurement element 13 is eighty-five degrees Celsius, but the temperature of the temperature-sensing element 26 is one-hundred degrees Celsius. The processor 15 calculates the difference in temperature between the temperature, which is eighty-five degrees Celsius, of the capacitor and the reduced rated temperature, which is seventy-five degrees Celsius, which is ten degrees Celsius. Then the processor 15 subtracts the difference in temperature, which is ten degrees Celsius, from the temperature of the temperature-sensing element 26, which is one-hundred degrees Celsius, and the result, ninety degrees Celsius, of the above subtraction is the thermal protection critical temperature of the switching power supply 20. When the temperature of the capacitor 22c reaches the reduced rated temperature of the capacitor 22c, the temperature of the temperature-sensing element 26 matches the thermal protection critical temperature. And the power controller 24 executes the thermal protection methods for the switching power supply 20 to prevent the capacitor 22c from working at a temperature which is too high.

The device 10 further includes a display 17 electronically connected to the processor 15. When the processor 15 calculates the thermal protection critical temperature of the switching power supply 20, the thermal protection critical temperature is displayed on the display 17.

A method for setting thermal protection critical temperature by using the device 10 for setting the thermal protection critical temperature includes following steps:

The device 10 and the switching power supply 20 are provided. The device 10 includes the high-temperature unit 11, the temperature measurement element 13, and the processor 15. The switching power supply 20 includes the plurality of power supply elements 22, the power controller 24, and the temperature-sensing element 26 electronically connected to the power controller 24.

The switching power supply 20 which provides loads is put into the high-temperature unit 11. The high-temperature unit 11 provides a high ambient temperature which is temperature of the switching power supply 20 in actual usage.

Each temperature of the power supply elements 22 and the temperature of the temperature-sensing element 26 are measured, and each temperature of the power supply elements 22 and the temperature of the temperature-sensing element 26 are transmitted to the processor 15.

Each temperature of the power supply elements 22 is compared with the reduced rated temperatures of the power supply elements 22.

When at least one temperature of the power supply elements 22 is greater than the reduced rated temperature of the power supply elements 22, the processor 15 calculates the difference in temperature between the temperature of the at least one power supply element 22 and the reduced rated temperature of the power supply element 22. The processor 15 subtracts the largest difference in temperature from the temperature of the temperature-sensing element 26, and the result of above subtraction is the thermal protection critical temperature of the switching power supply 20.

It is to be further understood that even though numerous characteristics and advantages of the present embodiments have been set forth in the foregoing description, together with details of structures and functions of various embodiments, the disclosure is illustrative only, and changes may be made in detail, especially in the matter of arrangement of parts within the principles of the present disclosure to the full extent indicated by the broad general meaning of the terms in which the appended claims are expressed.

What is claimed is:

1. A device for setting a thermal protection critical temperature of a switching power supply, wherein the switching power supply comprises a plurality of power supply elements and a temperature-sensing element, each of the temperature-sensing elements having a reduced rated temperature corresponding to the temperature-sensing element, the device comprising:
a high-temperature unit containing the switching power supply and providing a high ambient temperature about equal to an ambient temperature of the switching power supply in a working state;
a processor; and
a temperature measurement element electronically connected to the processor, measuring temperatures of the power supply elements and a temperature of the temperature-sensing element, and transmitting the temperatures of the power supply elements and the temperature of the temperature-sensing element to the processor;
wherein the processor compares the temperatures of the power supply elements with reduced rated temperatures of the power supply elements, and when at least one of the temperature of the power supply element is greater than the reduced rated temperature of the power supply element, the processor calculates a difference in temperature between the temperature of the power supply element and the reduced rated temperature of the power supply element, and the processor further subtracts a greatest difference from the temperature of the temperature-sensing element.

2. The device of claim 1, wherein the temperature measurement element is a thermocouple wire.

3. A system for setting a thermal protection critical temperature, comprising:
a memory;
at least one processor; and
a switching power supply comprising a plurality of power supply elements and a temperature-sensing element, wherein each of the power supply elements has a reduced rated temperature;
a device for setting a thermal protection critical temperature of the switching power supply, wherein the device includes a high-temperature unit, the processor, and a temperature measurement element electronically connected to the processor;
wherein the high-temperature unit contains the switching power supply which is working and provides a high ambient temperature;
wherein the temperature measurement element measures temperatures of power supply elements and a temperature of a temperature-sensing element and transmits the temperatures to the processor; and
wherein the processor compares the temperatures of the power supply elements with reduced rated temperatures of the power supply elements, and when at least one of the temperature of the power supply elements is larger than the reduced rated temperature of the power supply element, the processor calculates a difference in temperature between the temperature of the power supply element and the reduced rated temperature of the power supply element, and the processor further subtract a largest difference in temperature from the temperature of the temperature-sensing element, and the result of above subtraction is the thermal protection critical temperature of the switching power supply.

4. The system of claim 3, wherein the temperature measurement element is a thermocouple wire.

5. The system of claim 3, wherein the switching power supply includes a power controller electronically connected to the temperature-sensing element, and the power controller executes thermal protection methods when the temperature of the temperature-sensing element reaches the thermal protection critical temperature of the switching power supply.

6. The system of claim 3, wherein the temperature-sensing element is a thermistor.

7. The system of claim 3, wherein the power supply elements include metal-oxide-semiconductor field-effect transistors, inductors, and capacitors.

8. A method for setting a thermal protection critical temperature, the method comprising:
providing a switching power supply and a device for setting a thermal protection critical temperature, wherein the device comprises a high-temperature unit, a temperature measurement element, and a processor, wherein the switching power supply includes a plurality of power supply elements, a power controller, and a temperature-sensing element electronically connected to the power controller;
measuring each temperature of the each power supply element and a temperature of the temperature-sensing element, and transmitting the temperatures to the processor;
comparing the temperatures of the power supply elements with reduced rated temperatures of the power supply elements;
calculating a difference in temperature between the temperatures of the at least one power supply elements and the reduced rated temperatures of the power supply elements; and
subtracting a largest difference in temperature from the temperature of the temperature-sensing element, wherein the result of above subtraction is the thermal protection critical temperature of the switching power supply.

9. A non-transitory computer-readable storage medium having stored thereon instructions that, when executed by at least one processor of a computing device, cause the computing device to perform a method for setting a thermal protection critical temperature, the method comprising:
providing a switching power supply and a device for setting a thermal protection critical temperature, wherein the device comprises a high-temperature unit, a temperature measurement element, and a processor, wherein the switching power supply includes a plurality of power supply elements, a power controller, and a temperature-sensing element electronically connected to the power controller;
measuring each temperature of the each power supply element and a temperature of the temperature-sensing element, and transmitting the temperatures to the processor;
comparing the temperatures of the power supply elements with reduced rated temperatures of the power supply elements;
calculating a difference in temperature between the temperatures of the at least one power supply elements and the reduced rated temperatures of the power supply elements; and
subtracting a largest difference in temperature from the temperature of the temperature-sensing element, wherein the result of above subtraction is the thermal protection critical temperature of the switching power supply.
